(19) United States
(12) Patent Application Publication
(10) Pub. No.: US 2015/0189349 A1
(43) Pub. Date: Jul. 2, 2015

(54) SYSTEM AND METHOD FOR DELIVERING MEDIA CONTENT MODIFIED ACCORDING TO A RATING

(71) Applicant: Stuart Andrew Nelson, Minnetonka, MN (US)

(72) Inventor: Stuart Andrew Nelson, Minnetonka, MN (US)

(21) Appl. No.: 14/142,846

(22) Filed: Dec. 28, 2013

(51) Int. Cl. H04N 21/2668; H04N 21/239; H04N 21/6587; H04N 21/643

(52) U.S. Cl. CPC H04N 21/2668; H04N 21/64322; H04N 21/2393; H04N 21/6587

(57) ABSTRACT

A method of delivering media content includes receiving a first media content request for a first media content from a first user and receiving a first rating request for a first rating from the first user. The first media content is designated with a second rating which is different than the first rating. The first media content is modified according to the first rating to create a modified first media content. The modified first media content is then delivered to the first user.

### BACKGROUND

The present invention relates to media content, and in particular, to the ratings of media content such as movies.

Media content providers provide various types of media content, such as motion pictures or movies, to users over various formats, such as streaming over the Internet to a computer or directly to a television set, through video downloads, through broadcast television, through cable television, through satellite television, via optical discs such as digital video discs and Blu-Ray discs, as well as other formats. Media content can be designed or designated for particular users. For example, some media content is designed for adult viewers and may contain some material that may not be suitable for younger viewers. Other media content can be designed specifically for younger viewers.

Various rating systems have been developed to assist viewers in determining whether particular media content is suitable for their preferences and circumstances. For example, the Classification and Rating Administration (CARA) has developed the Film Rating System that designates ratings for movies submitted to CARA for review. CARA has designated movies with ratings of G: General Audiences, PG: Parental Guidance Suggested, PG-13: Parents Strongly Cautioned, R: Restricted, and NC-17: No One 17 and Under Admitted. If a parent wishes to watch a movie with his or her young child, that parent may elect to select from only those movies that are rated G or PG. If a parent wishes to watch an R rated movie, that parent may elect to watch that movie without his or her young child. That parent could alternatively elect to watch the R rated movie with his or her young child, but would then risk exposing his or her young child to potentially objectionable material in the movie.

### BRIEF DESCRIPTION OF THE DRAWINGS

FIG. 1 is a schematic view of a system for delivering modified media content.

FIG. 2 is a block diagram of a method for delivering modified media content.

### SUMMARY

According to one embodiment, a method of delivering movies includes receiving a first movie request for a first movie from a first user, wherein the first movie is designated with a first rating, and receiving a first rating request for a second rating from the first user, wherein the second rating is different than the first rating. The first movie is modified according to the second rating to create a modified first movie. The modified first movie is delivered to the first user.

Another embodiment is a method of delivering media content. The method includes receiving a first media content request for a first media content from a first user, wherein the first media content is designated with a first rating, and receiving a first rating request for a second rating from the first user, wherein the second rating is different than the first rating. The first media content is modified according to the second rating to create a modified first media content. The modified first media content is delivered to the first user.

Another embodiment is another method of delivering media content. The method includes receiving a plurality of media content requests for a plurality of media content from a plurality of users and receiving a plurality of rating requests for a plurality of user selected ratings from the plurality of users. The plurality of media content is modified according to the plurality of user selected ratings to create a plurality of modified media content. The plurality of modified media content is delivered to the plurality of users such that each of the plurality of users receives customized media content.

### DETAILED DESCRIPTION

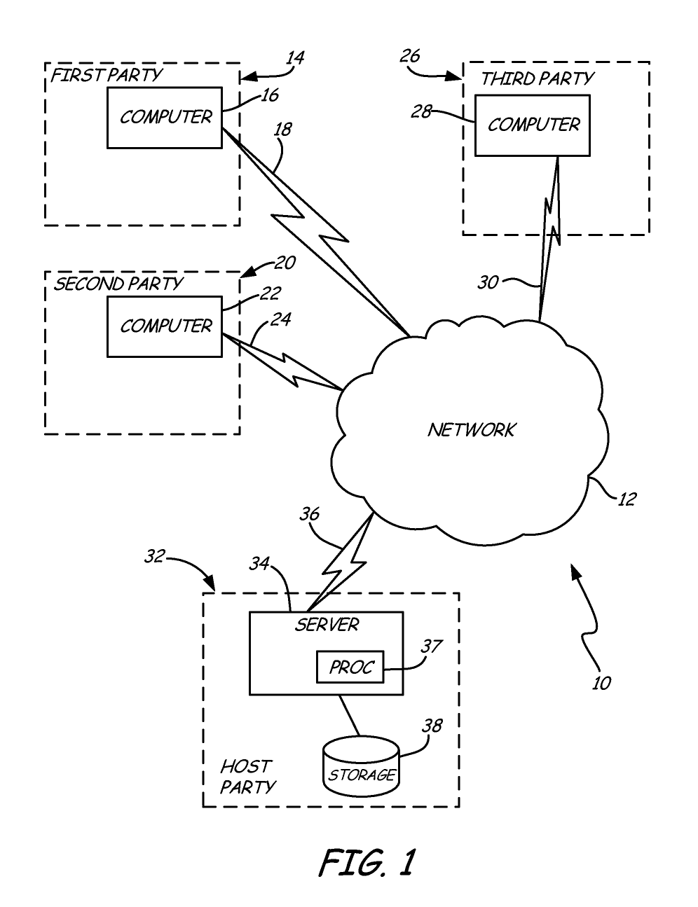

FIG. 1 is a schematic view of a system 10 for delivering modified media content. The system 10 includes a network 12 connected to a first party 14 via a first computer 16 over a first communication link 18, a second party 20 via a second computer 22 over a second communication link 24, a third party 26 via a third computer 28 over a third communication link 30, and a host party 32 via a server 34 over a fourth communication link 36. The server 34 includes a processor 37 and is connected to one or more computer storage media 38.

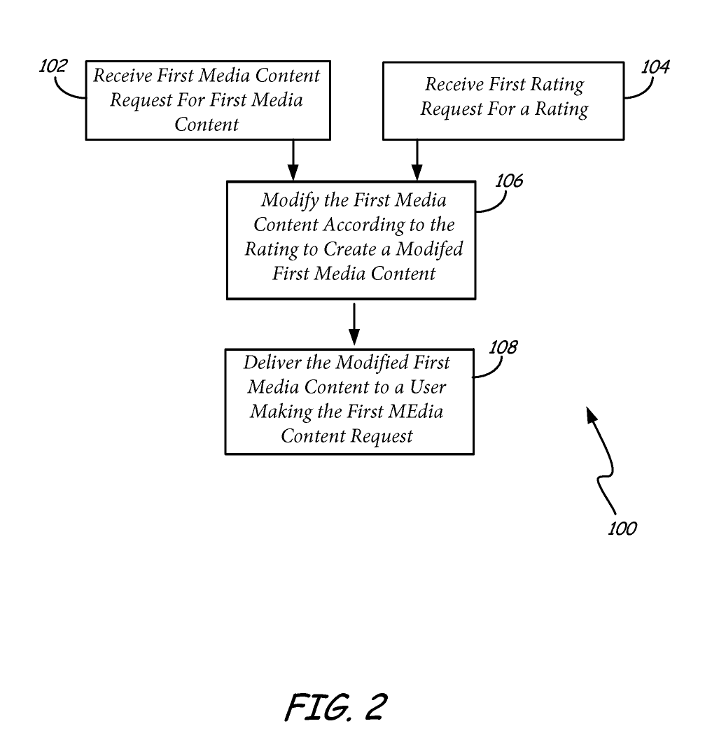

The first, second, and third computers 16, 22, and 28 can communicate over the network 12, such as the Internet or other network. The first, second, and third computers 16, 22, and 28 can communicate over the network 12 via a suitable browser, such as Internet Explorer (shown in FIG. 2), Netscape Navigator, Mozilla Firefox, Opera, or Google Chrome. The first, second, and third computers 16, 22, and 28 can be a television set, an optical disc player, a laptop computer, a computer workstation, a personal computer, a personal digital assistant, a cellular phone, a mobile phone, a smart phone, another telephone, a digital tablet, an internet appliance, or virtually any device suitable for communicating over the network 12 with the host party 32. The first, second, third, and fourth communication links 18, 24, 30, and 36 can be virtually any combination of wired and/or wireless communication mechanisms suitable for communicating over the network 12, such as one or more of Ethernet, Local Talk, Token Ring, FDDI, ATM, TCP, UDP, HTTP, FTP, Bluetooth, WiMax, 802.11a, 802.11b, 802.11g, 802.11n, a proprietary communications network, infrared, optical, or a public switched telephone network.

The host party 32 can be an operator of a website hosted on the server 34. The server 34 can be one or more servers connected to the one or more computer storage media 38, which can store media content as well as other information and images displayed on the website. The website can be displayed to a user accessing the website on a computer monitor, or other display. The website can be one of various formats, such as HTML, XML, or XHTML. The computer storage media 38 can be an electronic, optical, magnetic, or other storage or transmission device capable of providing a computer, such as the server 34, with computer-readable instructions, such as a floppy disk, CD-ROM, DVD, other optical disc, magnetic disc, memory chip, ROM, RAM, an ASIC, a configured processor, magnetic tape, or any other media from which a computer can read instructions. The instructions may comprise code from any suitable computer-programming language, such as C, C++, C#, Visual Basic, Java, Python, Perl, or JavaScript.

The host party 32 can be a provider of media content to users. The first party 14, the second party 20, and the third party 26 can be users of media content received from the host party 32. For example, the host party 32 can be a provider of video and/or audio media content, such as movies, via streaming over the Internet. The first, second, and third parties 14, 20, and 26 can be subscribers or otherwise users of services provided by the host party 32 for viewing movies or otherwise consuming media content from the host party 32.

The host party 32 can provide an interface, such as via a website, to allow users to review and select media content for consuming. That interface can include information describing or otherwise relating to the media content, such as movie ratings from the Classification and Rating Administration (CARA). Such ratings can include ratings of G: General Audiences, PG: Parental Guidance Suggested, PG-13: Parents Strongly Cautioned, R: Restricted, and NC-17: No One 17 and Under Admitted.

A user can select media content for viewing and the host party 32 can deliver that media content to the user in its original format. For example, the first party 14 can select a movie having an R rating and the host party 32 can deliver that movie to the first party 14 in its original format including all of the material that originally caused the movie to be designated with an R rating.

Alternatively, the first party 14 can request the movie designated with the R rating, but can request a different rating, such as PG. The host party 32 can then modify the movie according to the PG rating to create a modified movie having potentially objectionable content removed. The host party 32 can then deliver the modified movie to the first party 14 to be viewed by the first party 14 in its modified format.

FIG. 2 is a block diagram 100 of one embodiment of a method for delivering modified media content. In step 102, the host party 32 can receive a first media content request for first media content from a first user. The first media content can be designated with a first rating by a rating organization. For example, the first party 14 can request a first movie. The first movie can be designated with an R rating by CARA.

In step 104, the host party 32 can receive a first rating request for a second rating from the first user. The second rating can be different than the first rating designated for the first media content. For example, the second rating can be PG or another rating less restrictive than the first rating (such as G or PG-13).

In step 106, the host party 32 can modify the first media content according to the second rating to create a modified first media content. For example, the host party 32 can modify the first movie to delete or otherwise alter potentially objectionable material to create a modified first movie that includes less or no potentially objectionable material. The content in the modified first movie may no longer necessitate an R rating, and can instead justify or approximately justify a PG or other less restrictive rating. In some embodiments, the first movie can be modified by deleting or altering objectionable audio, such as objectionable language. Objectionable language can be silenced or overwritten by a bleep or by other language. In some embodiments, the first movie can be modified by deleting or altering objectionable video, such as objectionable images of violence, gruesomeness, or nudity. The objectionable images can be omitted or covered by one or more other images. In some embodiments, the movie can be modified by deleting or altering both video and audio. For example, entire tracks of audio and video or even entire sections of the media content can be omitted.

The host party 32 can modify the media content directly in response to receiving the first rating request, or can modify the media content prior to receiving the first rating request. The media content can be modified by the host party 32 itself, or can be modified by another party. The host party 32 can itself determine how best to modify the media content according to the second rating request or can modify the media content as designated by a rating organization.

In step 108, the host party 32 can deliver the modified first media content to the first user. For example, the host party 32 can deliver the modified first movie to the first party 14 over the network 12, such as the internet, as a streaming movie, as a movie download, or via another mechanism. Alternatively, the host party 32 can deliver the modified first media content to the first party 14 via a physical medium, such as by delivering a digital video disc or a Blu-Ray disc.

The user can then consume the media content as desired by the user. For example, the first party 14 can be a family that desires to watch an R rated movie but in a PG format. The first party 14 can set the second rating as a default rating, such that second, third, and subsequent request for movies or other media content can be modified according to the second rating. Alternatively, the first party 14 can select different desired ratings for second, third, and subsequent requests.

The method of the block diagram 100 can be repeated for additional users, such as the second party 20 and the third party 26. For example, the second party 20 can request the first movie and request a G rating and the third party can request the first movie and request an R rating. The host party 32 can then modify the first movie according to the G rating and deliver that modified movie to the second party 20. The host party can also deliver the first movie to the third party in its original R rated format. Thus, the third party 26 can provide movies and/or other media content to various users in an original format or in a modified format customized to each of the various users' preferences.

In alternative embodiments, the first and second rating can be ratings from a rating organization other than CARA, such as the Federal Communications Commission and/or virtually any other ratings organization. Alternatively, the first and second rating can be ratings governed by the host party 32. For example, the host party 32 can designate different ratings for different categories, such as violence, language, and nudity. Users can select different ratings for the different categories. For example, the first party 14 can be sensitive to violence but not to language. The host party 32 can modify media content according to the ratings of the first party by deleting scenes of objectionable violence but without omitting any objectionable audio for language. The second party 20 can be sensitive to nudity but not to violence. The host party 32 can modify media content according to the ratings of the second party by deleting scenes of objectionable nudity but without omitting any objectionable scenes for violence (unless deemed to also be objectionable due to nudity).

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the appended claims. For example, the host party 32 can deliver media content other than movies, such as other media content including audio and/or video.

1. A method of delivering movies, the method comprising:
receiving a first movie request for a first movie from a first user, wherein the first movie is designated with a first rating;
receiving a first rating request for a second rating from the first user, wherein the second rating is different than the first rating;
modifying the first movie according to the second rating to create a modified first movie; and
delivering the modified first movie to the first user.

2. The method of claim 1, wherein the first and second ratings are ratings defined by the Classification and Rating Administration (CARA) and wherein the first rating is that assigned to the first movie by CARA.

3. The method of claim 2, wherein the first rating is R—Restricted and wherein the second rating is PG—Parental Guidance Suggested.

4. The method of claim 1, wherein the modified first movie is delivered to the first user over an internet network.

5. The method of claim 4, wherein the modified first movie is delivered to the first user via streaming over the internet network.

6. The method of claim 1, and further comprising:
setting the second rating to a default rating for the first user; and
modifying movies for subsequent movie requests from the first user according to the second rating.

7. The method of claim 1, and further comprising:
receiving a second movie request for the first movie from a second user, wherein the first movie is designated with the first rating;
receiving a second rating request for a third rating from the second user, wherein the third rating is different than the first rating and the second rating;
modifying the first movie according to the third rating to create a second modified first movie; and
delivering the second modified first movie to the second user.

8. The method of claim 7, wherein the second rating includes a restriction on violence without any restriction on language and wherein the third rating includes a restriction on nudity without any restriction on violence.

9. The method of claim 1, wherein the method of delivering movies comprises a computer implemented method of delivering movies.

10. A method of delivering media content, the method comprising:
receiving a first media content request for a first media content from a first user, wherein the first media content is designated with a first rating;
receiving a first rating request for a second rating from the first user, wherein the second rating is different than the first rating;
modifying the first media content according to the second rating to create a modified first media content; and
delivering the modified first media content to the first user.

11. The method of claim 10, wherein the first and second ratings are ratings defined by the Classification and Rating Administration (CARA) and wherein the first rating is that assigned to the first media content by CARA.

12. The method of claim 10, wherein the modified first media content is delivered to the first user over an internet network.

13. The method of claim 12, wherein the modified first media content is delivered to the first user via streaming over the internet network.

14. The method of claim 10, and further comprising:
setting the second rating to a default rating for the first user; and
modifying additional media content for subsequent media content requests from the first user according to the second rating.

15. The method of claim 10, and further comprising:
receiving a second media content request for the first media content from a second user, wherein the first media content is designated with the first rating;
receiving a second rating request for a third rating from the second user, wherein the third rating is different than the first rating and the second rating;
modifying the first media content according to the third rating to create a second modified first media content; and
delivering the second modified first media content to the second user.

16. The method of claim 15, wherein the second rating includes a restriction on violence without any restriction on language and wherein the third rating includes a restriction on nudity without any restriction on violence.

17. The method of claim 10, wherein the method of delivering media content comprises a computer implemented method of delivering media content.

18. A method of delivering media content, the method comprising:
receiving a plurality of media content requests for a plurality of media content from a plurality of users;
receiving a plurality of rating requests for a plurality of user selected ratings from the plurality of users;
modifying the plurality of media content according to the plurality of user selected ratings to create a plurality of modified media content; and
delivering the plurality of modified media content to the plurality of users such that each of the plurality of users receives customized media content.

19. The method of claim 18, wherein the media content comprises movies and wherein the plurality of ratings are ratings defined by the Classification and Rating Administration (CARA).

20. The method of claim 18, wherein the method of delivering media content comprises a computer implemented method of delivering media content.
